(19) United States
(12) Patent Application Publication
(10) Pub. No.: US 2009/0075664 A1
(43) Pub. Date: Mar. 19, 2009

(54) MULTIPLEXED BEACON SYMBOLS FOR A WIRELESS COMMUNICATION SYSTEM

(75) Inventors: Ravi Palanki, San Diego, CA (US); Avneesh Agrawal, San Diego, CA (US); Aamod Khandekar, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/206,528

(22) Filed: Sep. 8, 2008

Related U.S. Application Data
(60) Provisional application No. 60/972,530, filed on Sep. 14, 2007.

(51) Int. Cl. H04W 40/00

(52) U.S. Cl. 455/446

(57) ABSTRACT

Techniques for transmitting information using beacon symbols are described. A transmitter may map first information to at least one subcarrier in a first set of subcarriers, with the first information being conveyed by the position of the at least one subcarrier. The transmitter may map second information to one or more subcarriers in a second set of subcarriers. The second information may be conveyed by one or more modulation symbols sent on the one or more subcarriers. The transmitter may generate at least one beacon symbol having the first information mapped to the at least one subcarrier in the first set and the second information mapped to the one or more subcarriers in the second set. In one design, the transmitter may frequency division multiplex the first information with the second information. In another design, the transmitter may puncture the second information on the at least one subcarrier with the first information.

The present application claims priority to provisional U.S. application Ser. No. 60/972,530, entitled “FDM BEACON,” filed Sep. 14, 2007, assigned to the assignee hereof and incorporated herein by reference.

### BACKGROUND

I. Field

The present disclosure relates generally to communication, and more specifically to techniques for transmitting information in a wireless communication system.

II. Background

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of base stations that can support communication for a number of terminals. A base station may transmit various types of information such as traffic data, control information, and pilot to one or more terminals. Control information may also be referred to as overhead information, signaling, etc. A terminal may also transmit various types of information to a base station. It is desirable for a transmitter to efficiently and reliably transmit different types of information to one or more receivers.

### SUMMARY

Techniques for transmitting information in a wireless communication system are described herein. In an aspect, a transmitter may generate beacon symbols comprising different information sent in different manners. In one design, the transmitter may map first information to at least one subcarrier in a first set of subcarriers, with the first information being conveyed by the position of the at least one subcarrier. The transmitter may map second information to one or more subcarriers in a second set of subcarriers. For example, the second information may be conveyed by one or more modulation symbols sent on the one or more subcarriers in the second set. The transmitter may generate at least one beacon symbol comprising the first information mapped to the at least one subcarrier in the first set and the second information mapped to the one or more subcarriers in the second set. Each beacon symbol may be an orthogonal frequency division multiplex (OFDM) symbol or a single-carrier frequency division multiplex (SC-FDM) symbol.

In one design, the transmitter may frequency division multiplex (FDM) the first information with the second information. For this design, the first set of subcarriers may be non-overlapping with the second set of subcarriers. In another design, the transmitter may puncture the second information on the at least one subcarrier with the first information. For this design, the first set of subcarriers may overlap (e.g., may be equal to) the second set of subcarriers. The first information may comprise a cell identifier (ID), a sector ID, and/or other information. The second information may comprise pilot, control information, traffic data, etc.

The transmitter may use higher transmit power for the at least one subcarrier used for the first information. This may allow receivers with low geometry to reliably receive the first information. The multiplexing of the first and second information in the same beacon symbol may improve bandwidth utilization.

Various aspects and features of the disclosure are described in further detail below.

### BRIEF DESCRIPTION OF THE DRAWINGS

FIG. 1 shows a wireless communication system.

FIG. 2 shows transmission of FDM beacon symbols.

FIG. 3 shows transmit power versus subcarrier for an FDM beacon symbol.

FIG. 4 shows transmission of punctured beacon symbols.

FIG. 5 shows transmit power versus subcarrier for a punctured beacon symbol.

FIG. 6 shows a block diagram of a base station and a terminal.

FIG. 7 shows a block diagram of a transmit processor.

FIG. 8 shows a block diagram of a receive processor.

FIG. 9 shows a process for transmitting information.

FIG. 10 shows an apparatus for transmitting information.

FIG. 11 shows a process for receiving information.

FIG. 12 shows an apparatus for receiving information.

### DETAILED DESCRIPTION

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2).

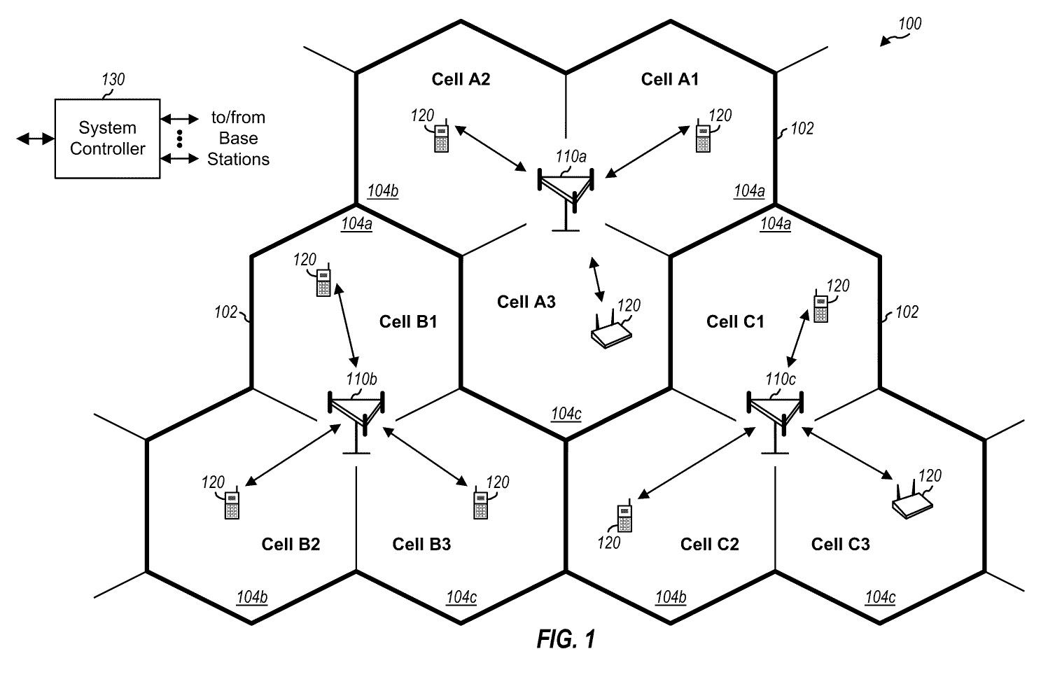

FIG. 1 shows a wireless communication system 100, which may include a number of base stations and other network entities. For simplicity, only three base stations 110a, 110b and 110c and one system controller 130 are shown in FIG. 1. A base station may be a fixed station that communicates with the terminals and may also be referred to as a Node B, an evolved Node B (eNB), an access point, a base transceiver station (BTS), etc. Each base station 110 provides communication coverage for a particular geographic area 102. To improve system capacity, the overall coverage area of a base station may be partitioned into multiple smaller areas, e.g., three smaller areas 104a, 104b and 104c. Each smaller area may be served by a respective base station subsystem. In 3 GPP, the term “cell” can refer to the smallest coverage area of a base station and/or a base station subsystem serving this coverage area. In 3GPP 2, the term “sector” can refer to the smallest coverage area of a base station and/or a base station subsystem serving this coverage area. For clarity, 3GPP concept of cell is used in the description below.

In the example shown in FIG. 1, each base station 110 has three cells that cover different geographic areas. For simplicity, FIG. 1 shows the cells not overlapping one another. In a practical deployment, adjacent cells typically overlap one another at the edges, which may allow a terminal to receive communication coverage from one or more cells at any location as the terminal moves about the system.

Terminals 120 may be dispersed throughout the system, and each terminal may be stationary or mobile. A terminal may also be referred to as a mobile station, a user equipment (UE), an access terminal, a subscriber unit, a station, etc. A terminal may be a cellular phone, a personal digital assistant (PDA), a wireless modem, a wireless communication device, a handheld device, a laptop computer, a cordless phone, etc. A terminal may communicate with a base station via the forward and reverse links. The forward link (or downlink) refers to the communication link from the base station to the terminal, and the reverse link (or uplink) refers to the communication link from the terminal to the base station.

System controller 130 may couple to a set of base stations and provide coordination and control for these base stations. System controller 130 may be a single network entity or a collection of network entities.

System 100 may utilize OFDM and/or SC-FDM. In general, modulation symbols are sent in the frequency domain with OFDM and in the time domain with SC-FDM. OFDM and SC-FDM partition the system bandwidth into multiple (K) orthogonal subcarriers, which are also commonly referred to as tones, bins, etc. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 MHz, respectively. A subset of the K total subcarriers may be usable for transmission, and the remaining subcarriers may serve as guard subcarriers. For simplicity, the following description assumes that all K total subcarriers are usable.

For OFDM, a transmitter (e.g., a base station or a terminal) may transmit up to K modulation symbols on up to K subcarriers in each OFDM symbol period. The modulation symbols may be mapped to subcarriers used for transmission, and zero symbols with signal value of zero may be mapped to remaining subcarriers. K mapped symbols may be transformed to the time domain with a K-point inverse fast Fourier transform (IFFT) to obtain a useful portion containing K time-domain samples. The last C samples of the useful portion may be copied and appended to the front of the useful portion to form an OFDM symbol containing K+C samples. The copied portion is referred to as a cyclic prefix, and C is the cyclic prefix length. The cyclic prefix is used to combat inter-symbol interference (ISI) caused by frequency selective fading. An OFDM symbol may be transmitted in one OFDM symbol period, which may include K+C sample periods.

For SC-FDM, the transmitter may perform an S-point discrete Fourier transform (DFT) on S modulation symbols to obtain S frequency-domain symbols, where S≧1. The S frequency-domain symbols may be mapped to S subcarriers used for transmission, and zero symbols may be mapped to remaining subcarriers. K mapped symbols may then be transformed with a K-point IFFT to obtain a useful portion. A cyclic prefix may be appended to the useful portion to form an SC-FDM symbol.

The techniques described herein may be used with OFDM, SC-FDM, and possibly other modulation techniques. For clarity, much of the description below assumes that the system utilizes OFDM and that information is sent in OFDM symbols. However, references to OFDM symbols in the description below may be replaced with SC-FDM symbols or some other transmission symbols.

A transmitter may transmit beacon symbols to one or more receivers. A beacon symbol is an OFDM symbol or an SC-FDM symbol that carries information in the position of one or more subcarriers, which are referred to as beacon subcarriers. For example, one bit of information may be used to select one of two subcarriers, two bits of information may be used to select one of four subcarriers, etc. Information is thus conveyed in which subcarriers are used as the beacon subcarriers instead of modulation symbols sent on the subcarriers. A beacon symbol may also be referred to as a beacon OFDM symbol, a beacon, etc. A beacon symbol may be transmitted using higher transmit power for the beacon subcarrier(s) and may thus be reliably detected by receivers even at low received signal quality. In the following description, signal-to-noise ratio (SNR) is used to denote received signal quality.

In an aspect, an OFDM symbol may carry beacon information as well as other information. Beacon information is information conveyed by the position of beacon subcarriers. Other information may be for traffic data, control information, and/or pilot and may be conveyed by modulation symbols sent on subcarriers. The multiplexing of beacon information and other information in the same OFDM symbol may provide certain advantages. First, beacon information may be reliably sent to receivers with low SNRs. Second, other information may also be sent in the OFDM symbol to better utilize the available bandwidth.

Table 1 lists different types of beacon symbols and provides a short description for each beacon symbol type. A beacon symbol may be (i) a pure beacon symbol carrying only beacon information or (ii) a multiplexed beacon symbol carrying both beacon information and other information. FDM beacon symbols and punctured beacon symbols are two types of multiplexed beacon symbols.

TABLE 1

| Beacon Symbol | |
|---|---|
| Type | Description |
| Beacon symbol | OFDM symbol carrying at least beacon information. |
| Pure beacon | OFDM symbol carrying only beacon information. |
| symbol | |
| Multiplexed | OFDM symbol carrying beacon information and other |
| beacon symbol | information. |
| FDM beacon | OFDM symbol carrying beacon information and other |
| symbol | information in different frequency segments using FDM. |
| Punctured | OFDM symbol in which beacon information punctures |
| beacon symbol | other information on the beacon subcarrier(s). |

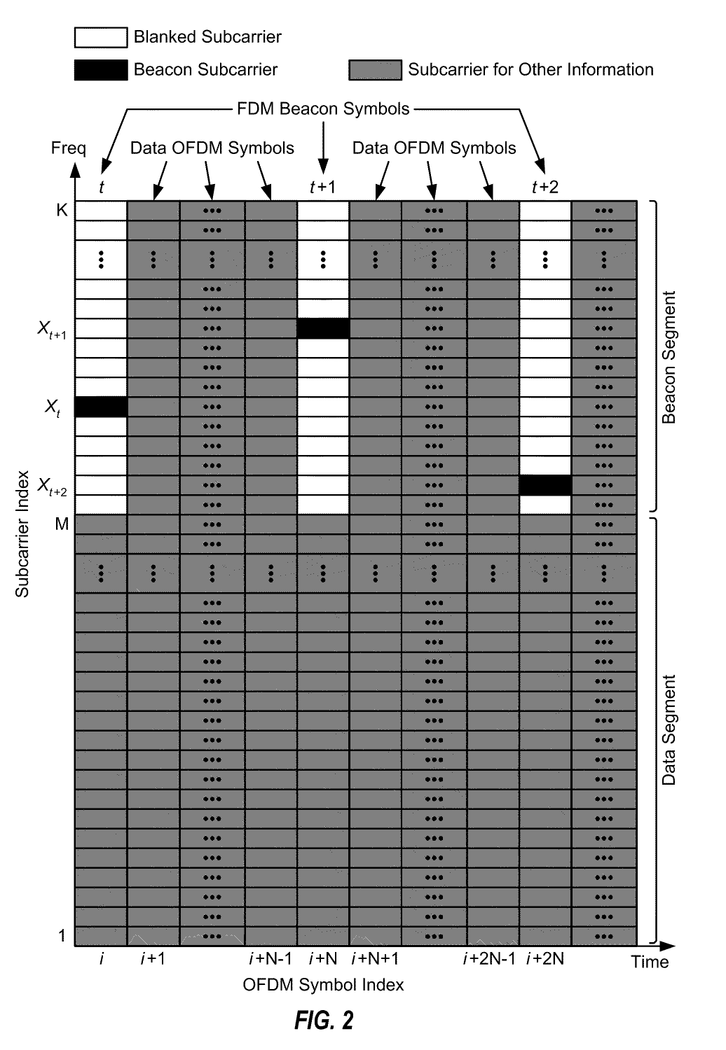

FIG. 2 shows a design of transmission of FDM beacon symbols. In this design, the system bandwidth may be partitioned into a beacon segment and a data segment. The beacon segment may include L subcarriers, and the data segment may include M subcarriers, where L may be any integer value less than K, and M≦K−L. The beacon segment may be assigned a static set of subcarriers or different sets of subcarriers in different time intervals. In one design, the system bandwidth may be partitioned into multiple subbands, and each subband may include a set of contiguous or non-contiguous subcarriers. One or more subbands may be used for the beacon segment, and the remaining subbands may be used for the data segment. In any case, the subcarriers in the beacon segment may be known a priori by both a transmitter and a receiver, or conveyed via broadcast information, or provided in some other manners.

An FDM beacon symbol may be sent in every N-th OFDM symbol periods, where N may be an integer value of one or greater. In one design, the transmission timeline may be partitioned into units of frames, with each frame including N OFDM symbol periods. An FDM beacon symbol may be sent in one OFDM symbol period of each frame. The frames may be radio frames, physical layer (PHY) frames, super-frames, etc. An FDM beacon symbol may also be sent in each OFDM symbol period with N=1.

In the example shown in FIG. 2, an FDM beacon symbol is sent in OFDM symbol period i, where i is an index for OFDM symbol period. This FDM beacon symbol carries beacon information on beacon subcarrier Xₜ, where t is an index for beacon symbol, and Xₜ is an index of the beacon subcarrier in the beacon symbol sent at time t. This FDM beacon symbol may also carry other information on the subcarriers in the data segment. An OFDM symbol containing any information may be sent in each of OFDM symbol periods i+1 through i+N−1. Another FDM beacon symbol is sent in OFDM symbol period i+N and carries beacon information on beacon subcarrier Xₜ₊₁. This FDM beacon symbol may also carry other information on the subcarriers in the data segment. FDM beacon symbols and OFDM symbols may be sent in other OFDM symbol periods in similar manner.

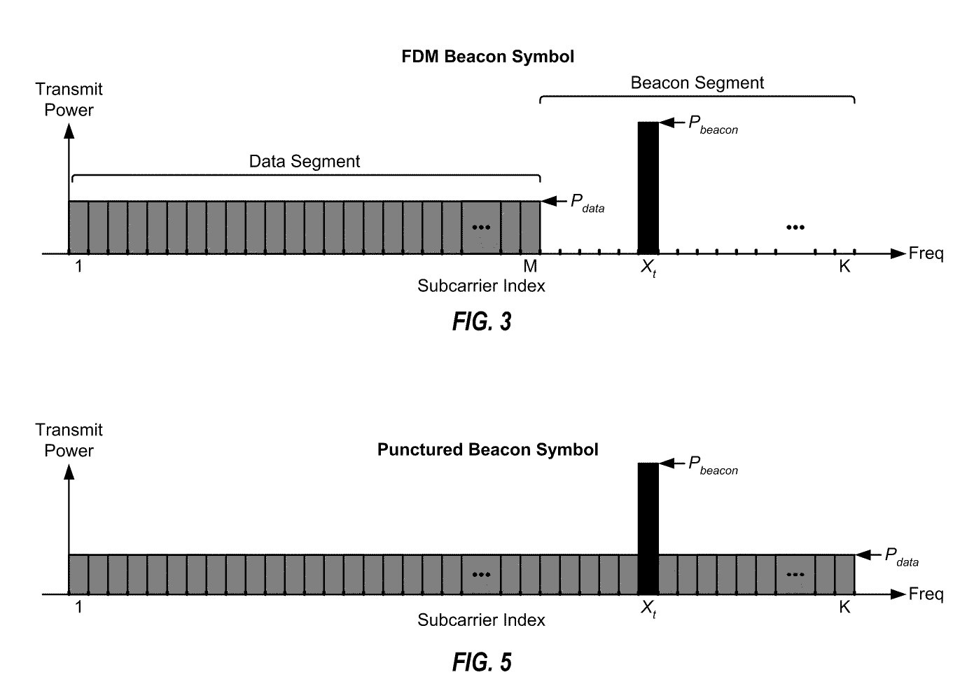

FIG. 3 shows a plot of transmit power versus subcarrier for one FDM beacon symbol. The terms “transmit power” and “energy” are related and are often used interchangeably. The available transmit power Pₐᵥₐₗᵢ for an OFDM symbol may be divided into beacon transmit power P_{beacon} and data transmit power P_{d}. The beacon transmit power is the fraction of the available transmit power that is allocated for beacon information. The data transmit power is the fraction of the available transmit power that is allocated for other information. In the example shown in FIG. 3, all of the beacon transmit power is used for beacon subcarrier Xₜ, which is transmitted at a transmit power level of P_{beacon}. The remaining subcarriers in the beacon segment may be blanked and may have a transmit power level of zero.

The data transmit power may be distributed across the subcarriers in the data segment. In the example shown in FIG. 3, the data transmit power is distributed uniformly across the M subcarriers in the data segment, and each subcarrier is transmitted at a transmit power level of P_{data}=P_{d}/M. In general, the data segment may carry one or more types of information, and the same or different transmit power levels may be used for different types of information. For example, pilot may be sent at a first transmit power level, control information may be sent at a second transmit power level, and traffic data may be sent at a third transmit power level. The first transmit power level may be adjusted with a power control loop to achieve the desired received signal quality for pilot. The second transmit power level may be adjusted to achieve the desired reliability for control information. The third transmit power level may be dependent on the remaining data transmit power.

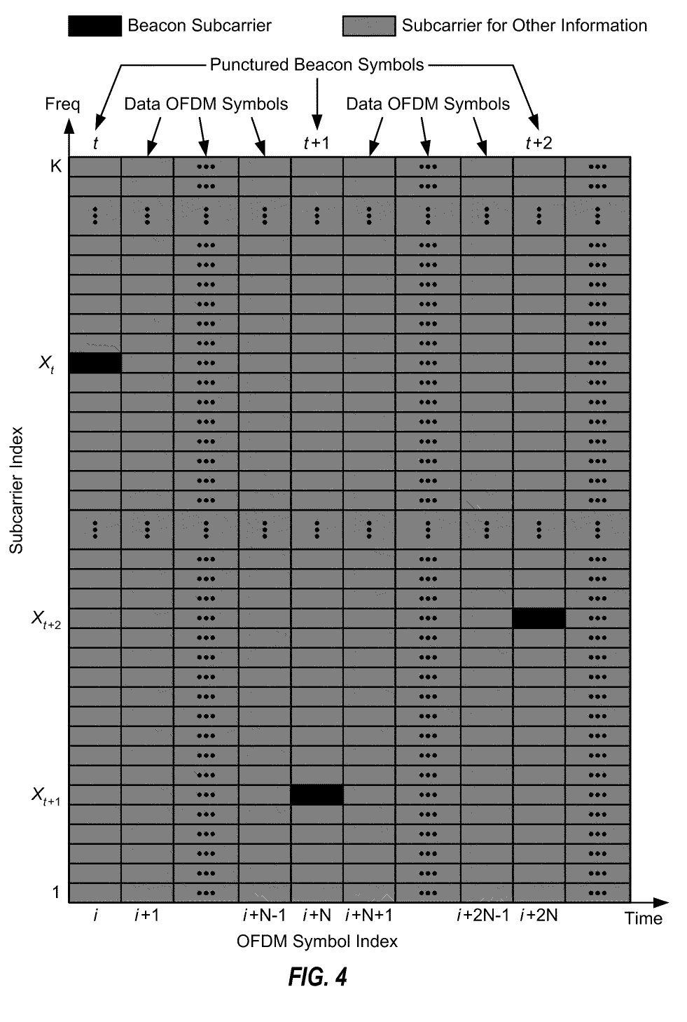

FIG. 4 shows a design of transmission of punctured beacon symbols. In this design, the entire system bandwidth may be used to send beacon information as well as other information. In general, a first set of subcarriers may be used for beacon information, a second set of subcarriers may be used for other information, and the two sets may completely or partially overlap one another. A punctured beacon symbol may be sent in every N-th OFDM symbol periods, where N≧1. In the example shown in FIG. 4, a punctured beacon symbol is sent in OFDM symbol period i. This punctured beacon symbol carries beacon information on beacon subcarrier Xₜ and may also carry other information on the remaining subcarriers. An OFDM symbol containing any information may be sent in each of OFDM symbol periods i+1 through i+N−1. Another punctured beacon symbol is sent in OFDM symbol period i+N. This punctured beacon symbol carries beacon information on beacon subcarrier Xₜ₊₁ and may also carry other information on the remaining subcarriers. Punctured beacon symbols and OFDM symbols may be sent in other OFDM symbol periods in similar manner.

FIG. 5 shows a plot of transmit power versus subcarrier for one punctured beacon symbol. The available transmit power Pₐᵥₐᵢₗ for an OFDM symbol may be divided into the beacon transmit power P_{beacon} and the data transmit power P_{d}. In the example shown in FIG. 5, all of the beacon transmit power is used for beacon subcarrier Xₜ, which is transmitted at a transmit power level of P_{beacon}. The data transmit power may be distributed across the subcarriers used for transmission. In the example shown in FIG. 5, the data transmit power is distributed uniformly across the K total subcarriers, and each subcarrier is transmitted at a transmit power level of P_{data}=P_{d}/K. In general, one or more types of information may be sent in a punctured beacon symbol, and the same or different transmit power levels may be used for different types of information.

For both FDM and punctured beacon symbols, the amount of transmit power to use for beacon information and the amount of transmit power to use for other information may be determined in various manners. In one design, a fixed fraction (e.g., 50% or some other percentage) of the available transmit power may be allocated for beacon information, and the remaining transmit power may be allocated for other information. The fixed fraction may be determined based on the desired coverage for the beacon information, the amount of beacon information to send, the coding scheme used for beacon information, etc. In another design, the beacon symbols may be targeted to receivers achieving a target geometry or better. The available transmit power may first be allocated to beacon information to achieve the desired reliability for beacon information for receivers with the target geometry. The remaining transmit power may then be allocated to other information. In yet another design, the available transmit power may first be allocated to other information, e.g., pilot, control information, etc. The remaining transmit power may then be allocated to beacon information. The available transmit power may be allocated to beacon information and other information in other manners.

In general, beacon information may comprise any type of information, which may be dependent on whether a transmitter is a base station or a terminal. If the transmitter is a base station, then the beacon information may comprise a cell ID or a sector ID, broadcast information, system information, control information, etc. If the transmitter is a terminal, then the beacon information may comprise control information, etc.

Beacon information may be sent using a beacon code. A beacon code is a code used for encoding beacon information at a transmitter and for decoding beacon information at a receiver. A beacon subcarrier index Xₜ may be considered as a non-binary symbol. A non-binary symbol is a symbol having one of more than two possible values and may also be referred to as a multi-bit symbol. A transmitter may process beacon information based on a beacon code to generate a sequence of non-binary symbols. The transmitter may send each non-binary symbol in one beacon symbol. A receiver may receive non-binary symbols from the beacon symbols. The receiver may decode the received non-binary symbols based on the beacon code to recover the beacon information sent by the transmitter.

A beacon code may be defined based on a polynomial code, a maximum distance separable (MDS) code, a Reed-Solomon code (which is one type of MDS code), or other types of code. For clarity, a specific beacon code based on a Reed-Solomon code is described below. For this beacon code, S=47 subcarriers are available to transmit beacon information and are assigned indices of 0 through 46. In general, S≦L for FDM beacon symbols and S≦K for punctured beacon symbols. In this example beacon code design, beacon information is sent in a 12-bit message. The beacon code should thus support at least 2¹²=4096 different sequences of non-binary symbols, with each possible message being mapped to a different sequence of non-binary symbols. Beacon symbols may be transmitted at different times given by index t, where t=0, 1, 2, . . . .

A message comprising beacon information may be mapped to a sequence of non-binary symbols Xₜ(α₁,α₂,α₃) which may be expressed as:

Xₜ(α₁,α₂,α₃)=p₁^{α}^{₁}^{2t}⊕p₁^{α}^{₂}p₂^{2t}⊕p₁^{α}^{₃}p₃^{2t}, Eq (1)

where p₁ is a primitive element of field Z₄₇, p₂=p₁², and p₃=p₁³,
α₁, α₂ and α₃ are exponent factors determined based on the message, and ⊕ denotes modulo addition.

Field Z₄₇ contains 47 elements from 0 through 46. A primitive element of field Z₄₇ is an element of Z₄₇ that may be used to generate all 46 non-zero elements of Z₄₇. As an example, for field Z₇ containing seven elements from 0 through 6, 5 is a primitive element of Z₇ and may be used to generates all 6 non-zero elements of Z₇ as follows: 5⁰ mod 7=1, 5¹ mod 7=5, 5² mod 7=4, 5³ mod 7=6, 5⁴ mod 7=2, and 5⁵ mod 7=3.

In equation (1), arithmetic operations are over field Z₄₇. For example, addition of A and B may be given as (A+B) mod 47, multiplication of A with B may be given as (A*B) mod 47, A raised to the power of B may be given as AB mod 47, etc. Additions within exponents are modulo-47 integer additions.

In one design, p₁=45, p₂=p₁²=4, and p₃=p₁³=39. Other primitive elements may also be used for p₁. The selection of p₂=p₁² and p₃=p₁³ results in a Reed-Solomon code with equation (1).

The exponent factors α₁, α₂ and α₃ may be defined as follows:

0≦α₁<2, 0≦α₂<46, and 0≦α₃<46. Eq (2)

A total of 2*46*46=4232 different combinations of α₁, α₂ and α₃ may be obtained with the constraints shown in equation set (2). Each unique combination of α₁, α₂ and α₃ corresponds to a different possible message and hence a different sequence of non-binary symbols for the beacon information. The 4232 different combinations of α₁, α₂ and α₃ can support a 12-bit message. A message may be mapped to a corresponding combination of α₁, α₂ and α₃, as follows:

Y=2116*α₁+46*α₂+α₃, Eq (3)

where Y is a 12-bit message value and is within a range of 0 to 4095. Other mappings between a message and a combination of α₁, α₂ and α₃ may also be used.

Since pᵢ⁴⁶=1, for i=1, 2, 3, the beacon code shown in equation (1) is periodic with a period of 46/2=23 symbols. Hence, Xₜ₊₂₃(α₁,α₂,α₃)=Xₜ(α₁,α₂,α₃) for any given value of t.

A transmitter may map a 12-bit message to a sequence of 23 non-binary symbols based on the beacon code shown in equation (1). The transmitter may send three or more consecutive non-binary symbols in the sequence for the message, one non-binary symbol in each beacon symbol.

A receiver can recover the message sent by the transmitter with three consecutive beacon symbols. The receiver may obtain three non-binary symbols x₁, x₂ and x₃ from three beacon symbols received at times t, t+1 and t+2, respectively. The received non-binary symbols may be expressed as:

$$\begin{matrix}{x}_{1} = {p}_{1}^{{α}_{1} + 2 t} ⊕ {p}_{1}^{{α}_{2}} {p}_{2}^{2 t} ⊕ {p}_{1}^{{α}_{3}} {p}_{3}^{2 t} , \\ {x}_{2} = {p}_{1}^{{α}_{1} + 2 ( t + 1 )} ⊕ {p}_{1}^{{α}_{2}} {p}_{2}^{2 ( t + 1 )} ⊕ {p}_{1}^{{α}_{3}} {p}_{3}^{2 ( t + 1 )} \\ = {p}_{1}^{2} {p}_{1}^{{α}_{1} + 2 t} ⊕ {p}_{2}^{2} {p}_{1}^{{α}_{2}} {p}_{2}^{2 t} ⊕ {p}_{3}^{2} {p}_{1}^{{α}_{3}} {p}_{3}^{2 t} , and \\ {x}_{3} = {p}_{1}^{{α}_{1} + 2 ( t + 2 )} ⊕ {p}_{1}^{{α}_{2}} {p}_{2}^{2 ( t + 2 )} ⊕ {p}_{1}^{{α}_{3}} {p}_{3}^{2 ( t + 2 )} \\ = {p}_{1}^{4} {p}_{1}^{{α}_{1} + 2 t} ⊕ {p}_{2}^{4} {p}_{1}^{{α}_{2}} {p}_{2}^{2 t} ⊕ {p}_{3}^{4} {p}_{1}^{{α}_{3}} {p}_{3}^{2 t} .\end{matrix} \qquad Eq ( 4 )$$

Equation set (4) may be expressed in matrix form as follows:

$$( \begin{matrix}{x}_{1} \\ {x}_{2} \\ {x}_{3}\end{matrix} ) = ( \begin{matrix}1 & 1 & 1 \\ {p}_{1}^{2} & {p}_{2}^{2} & {p}_{3}^{2} \\ {p}_{1}^{4} & {p}_{2}^{4} & {p}_{3}^{4}\end{matrix} ) ( \begin{matrix}{p}_{1}^{{α}_{1} + 2 t} \\ {p}_{1}^{{α}_{2}} {p}_{2}^{2 t} \\ {p}_{1}^{{α}_{3}} {p}_{3}^{2 t}\end{matrix} ) = B ( \begin{matrix}{p}_{1}^{{α}_{1} + 2 t} \\ {p}_{1}^{{α}_{2}} {p}_{2}^{2 t} \\ {p}_{1}^{{α}_{3}} {p}_{3}^{2 t}\end{matrix} ) . \qquad Eq ( 5 )$$

The receiver may solve for terms p₁^{α}^{₁}^{+2t}, p₁^{α}^{₂}p₂^{2t} and p₁^{α}^{₃}p₃^{2t} in equation (5), as follows:

$$( \begin{matrix}{y}_{1} \\ {y}_{2} \\ {y}_{3}\end{matrix} ) = {B}^{- 1} ( \begin{matrix}{x}_{1} \\ {x}_{2} \\ {x}_{3}\end{matrix} ) = ( \begin{matrix}{p}_{1}^{{α}_{1} + 2 t} \\ {p}_{1}^{{α}_{2}} {p}_{2}^{2 t} \\ {p}_{1}^{{α}_{3}} {p}_{3}^{2 t}\end{matrix} ) . \qquad Eq ( 6 )$$

The receiver may obtain the exponent of p₁^{α}^{₁}^{+2t} as follows:

z₁=log(y₁)/log(p₁)=α₁+2t. Eq (7)

The logarithm in equation (7) is over field Z₄₇. The exponent factor α₁ and time index t may be obtained from equation (7), as follows:

α₁=z₁ mod 2, and Eq (8a)

t=z₁ div 2. Eq (8b)

Factor α₂ may be determined by substituting t obtained from equation (8b) into y₂=p₁^{α}^{₂}p₂^{2t} to obtain p₁^{α}^{₂}, and then solving for α₂ based on p₁^{α}^{₂}. Similarly, factor α₃ may be determined by substituting t into y₃=p₁^{α}^{₃}p₃^{2t}, to obtain p₁^{α}^{₃}, and then solving for α₃ based on p₁^{α}^{₃}.

An example beacon code based on a Reed-Solomon code has been described above. Other beacon codes may also be used to send beacon information in beacon symbols.

In general, a transmitter may process beacon information based on a beacon code to generate a sequence of non-binary symbols. The transmitter may send a sufficient number of non-binary symbols in the sequence, e.g., one non-binary symbol in each beacon symbol. The number of non-binary symbols to send may be dependent on the beacon code, the beacon information being sent, etc.

A receiver may receive a set of beacon symbols from the transmitter and may determine the received power of each subcarrier in each beacon symbol. The receiver may recover the beacon information sent by the transmitter using hard-decision decoding and/or soft-decision decoding. For hard-decision decoding, the receiver may first determine the beacon subcarrier(s) for each beacon symbol. For each beacon symbol, the receiver may compare the received power of each subcarrier against a threshold and may declare a beacon subcarrier if the received power exceeds the threshold. The threshold may be determined based on the total received power, the beacon transmit power, the available transmit power, etc. The receiver may obtain a non-binary symbol for each beacon subcarrier in each beacon symbol and may then decode all non-binary symbols to recover the beacon information.

For soft-decision decoding, the receiver may first determine the total received power for each possible message that can be sent by the transmitter for the beacon information. For each possible message, the receiver may coherently or non-coherently combine the received powers of all beacon subcarriers (in different beacon symbols) for that message to obtain the total received power for the message. The receiver may obtain Q total received powers for Q possible messages, where Q may be equal to 4096 for 12-bit messages. In one design, the receiver may identify the message with the largest total received power and may provide this message as a decoded message if its total received power is above a threshold. The receiver may obtain at most one decoded message for this design. In another design, the receiver may compare the total received power for each message against the threshold and may provide the message as a decoded message if its total received power is above the threshold. The receiver may obtain zero, one, or more decoded messages for this design.

The receiver may also use a combination of hard-decision and soft-decision decoding. For example, the receiver may first perform hard-decision decoding and obtain a detected message. The receiver may then compare the total received power of the beacon subcarriers for this detected message against a threshold. The receiver may provide the detected message as a decoded message if the total received power exceeds the threshold.

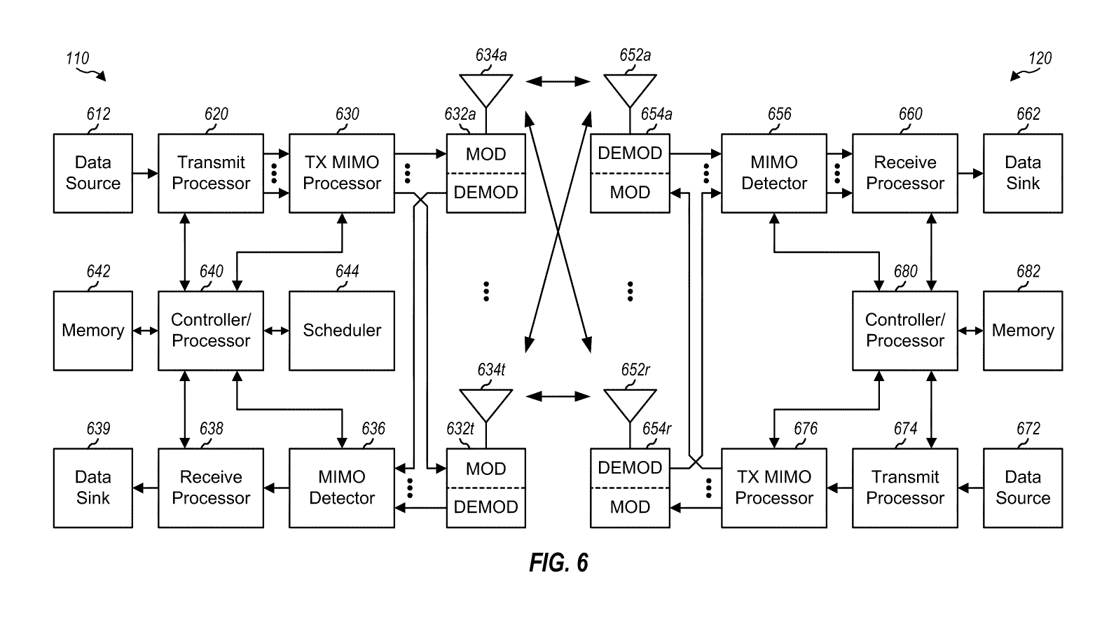

FIG. 6 shows a block diagram of a design of a base station 110 and a terminal 120, which may be one of the base stations and one of the terminals in FIG. 1. In this design, base station 110 is equipped with T antennas 634a through 634t, and terminal 120 is equipped with R antennas 652a through 652r, where in general T≧1 and R>1.

At base station 110, a transmit processor 620 may receive traffic data from a data source 612 for one or more terminals, process the traffic data for each terminal based on one or more modulation and coding schemes, and provide data modulation symbols for all terminals. Transmit processor 620 may also process beacon information and other information and provide control modulation symbols. A transmit (TX) multiple-input multiple-output (MIMO) processor 630 may multiplex the data modulation symbols, the control modulation symbols, pilot symbols, and possibly other symbols. TX MIMO processor 630 may perform spatial processing (e.g., preceding) on the multiplexed symbols, if applicable, and provide T output symbol streams to T modulators (MODs) 632a through 632t. Each modulator 632 may process a respective output symbol stream (e.g., for OFDM, SC-FDM, etc.) to obtain an output sample stream. Each modulator 632 may further process (e.g., convert to analog, amplify, filter, and upconvert) the output sample stream to obtain a forward link signal. T forward link signals from modulators 632a through 632t may be transmitted via T antennas 634a through 634t, respectively.

At terminal 120, antennas 652a through 652r may receive the forward link signals from base station 110 and may provide received signals to demodulators (DEMODs) 654a through 654r, respectively. Each demodulator 654 may condition (e.g., filter, amplify, downconvert, and digitize) a respective received signal to obtain received samples. Each demodulator 654 may further process the received samples (e.g., for OFDM, SC-FDM, etc.) to obtain received symbols. A MIMO detector 656 may obtain received symbols from all R demodulators 654a through 654r, perform MIMO detection on the received symbols if applicable, and provide detected symbols. A receive processor 660 may process (e.g., demodulate, deinterleave, and decode) the detected symbols, provide decoded traffic data for terminal 120 to a data sink 662, and provide decoded beacon information and other information to a controller/processor 680.

On the reverse link, at terminal 120, traffic data from a data source 672 and control information from controller/processor 680 may be processed by a transmit processor 674, precoded by a TX MIMO processor 676 if applicable, processed by modulators 654a through 654r (e.g., for OFDM or SC-FDM), and transmitted to base station 110. At base station 110, the reverse link signals from terminal 120 may be received by antennas 634, demodulated by demodulators 632, processed by a MIMO detector 636 if applicable, and further processed by a receive processor 638 to obtain the traffic data and control information transmitted by terminal 120.

Controllers/processors 640 and 680 may direct the operation at base station 110 and terminal 120, respectively. Memories 642 and 682 may store data and program codes for terminal 120 and base station 110, respectively. A scheduler 644 may schedule terminals for transmission on the forward and reverse links and may provide assignments of resources for the scheduled terminals.

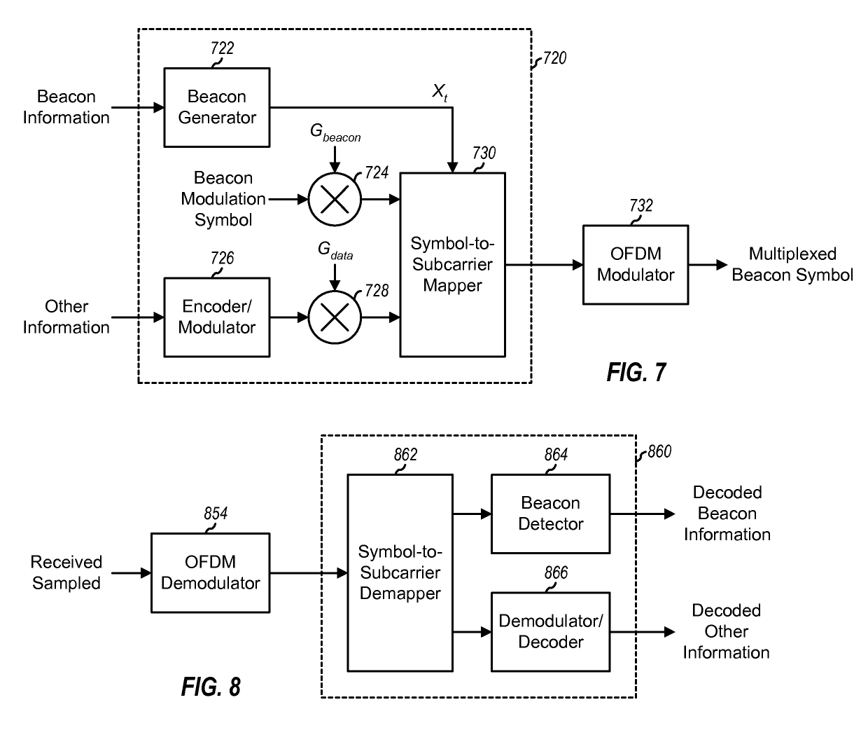

FIG. 7 shows a block diagram of a design of a transmit processor 720, which may be part of transmit processor 620 or 674 in FIG. 6. Within transmit processor 720, a beacon generator 722 may receive and process beacon information based on a beacon code and provide a sequence of non-binary symbols. A multiplier 724 may multiply a beacon modulation symbol with a gain G_{beacon} determined by the beacon transmit power P_{beacon}. A beacon modulation symbol is a modulation symbol used for beacon and may be a fixed complex value. An encoder/modulator 726 may receive and encode other information based on a coding scheme to obtain coded data and may map the coded data to modulation symbols based on a modulation scheme. A multiplier 728 may multiply the modulation symbols from unit 726 with a gain G_{data} determined by the data transmit power P_{data}.

To generate an FDM beacon symbol, a symbol-to-subcarrier mapper 730 may map the scaled beacon modulation symbol from multiplier 724 to a beacon subcarrier determined by a non-binary symbol Xt from beacon generator 722. Mapper 730 may map zero symbols to remaining subcarriers in the beacon segment. Mapper 730 may also map the scaled modulation symbols from multiplier 728 to subcarriers in the data segment. To generate a punctured beacon symbol, mapper 730 may first map the scaled modulation symbols from multiplier 728 to the K total subcarriers. Mapper 730 may then replace or puncture the modulation symbol mapped to a beacon subcarrier with the scaled beacon modulation symbol from multiplier 724. In either case, mapper 730 may provide K mapped symbols for the K total subcarriers. An OFDM modulator 732 may generate an OFDM symbol with the K mapped symbols and may provide this OFDM symbol as a multiplexed beacon symbol.

FIG. 8 shows a block diagram of a design of a receive processor 860, which may be part of receive processor 638 or 660 in FIG. 6. An OFDM demodulator 854 may perform OFDM demodulation on received samples and provide K received symbols for K total subcarriers in each OFDM symbol period.

Within receive processor 860, a symbol-to-subcarrier demapper 862 may obtain K received symbols for each OFDM symbol. For an FDM beacon symbol, demapper 862 may provide received symbols for subcarriers in the beacon segment to a beacon detector 864 and may provide received symbols for subcarriers in the data segment to a demodulator/decoder 866. Beacon detector 864 may perform hard-decision and/or soft-decision decoding on the received symbols from demapper 862 and provide decoded beacon information. Demodulator/decoder 866 may perform demodulation and decoding on the received symbols from demapper 862 and provide decoded other information.

For a punctured beacon symbol, demapper 862 may provide received symbols for all K subcarriers to both beacon detector 864 and demodulator/decoder 866. Beacon detector 864 may perform hard-decision and/or soft-decision decoding on the received symbols and provide decoded beacon information. Beacon detector 864 may also inform demodulator/decoder 866 of the beacon subcarriers. Demodulator/decoder 866 may discard the received symbols for the beacon subcarriers, perform demodulation and decoding on the remaining received symbols, and provide decoded other information

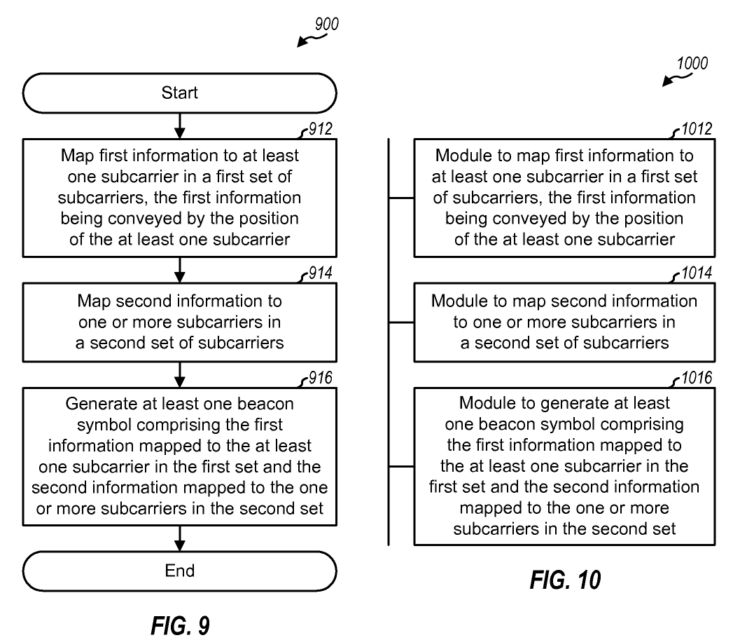

FIG. 9 shows a design of a process 900 for transmitting information in a wireless communication system. Process 900 may be performed by a transmitter, which may be a base station, a terminal, or some other entity.

The transmitter may map first information (e.g., beacon information) to at least one subcarrier in a first set of subcarriers, with the first information being conveyed by the position of the at least one subcarrier (block 912). The transmitter may map second information (e.g., other information) to one or more subcarriers in a second set of subcarriers(block 914). In one design, the second information may be conveyed by one or more modulation symbols sent on the one or more subcarriers in the second set. The second information may also be mapped to the one or more subcarriers in the second set in other manners and/or based on other modulation techniques. The transmitter may generate at least one beacon symbol comprising the first information mapped to the at least one subcarrier in the first set and the second information mapped to the one or more subcarriers in the second set (block 916). Each beacon symbol may have at least one subcarrier used for the first information and may be an OFDM symbol, an SC-FDM symbol, etc.

In one design, the transmitter may frequency division multiplex the first information with the second information, e.g., as shown in FIGS. 2 and 3. For this design, the first set of subcarriers may be non-overlapping with the second set of subcarriers. For example, the system bandwidth may be partitioned into multiple subbands. The first set of subcarriers may belong in at least one of the multiple subbands. The second set of subcarriers may belong in remaining ones of the multiple subbands. In another design, the transmitter may puncture the second information on the at least one subcarrier with the first information, e.g., as shown in FIGS. 4 and 5. For this design, the first set of subcarriers may partially or completely overlap (e.g., may be equal to) the second set of subcarriers.

The transmitter may determine first transmit power for the first information based on (i) a predetermined percentage of the available transmit power, (ii) an amount of transmit power to achieve a target reliability for the first information, or (iii) some other transmit power allocation scheme. The transmitter may use the first transmit power for at least one modulation symbol sent on the at least one subcarrier in the first set for the first information. The transmitter may also determine second transmit power for the second information. The transmitter may use the second transmit power for (e.g., distribute the second transmit power across) one or more modulation symbols sent on the one or more subcarriers in the second set for the second information, e.g., as shown in FIGS. 3 and 5.

In one design of block 912, the transmitter may encode the first information based on a beacon code to obtain at least one non-binary symbol. The transmitter may then determine the at least one subcarrier to use for the first information based on the at least one non-binary symbol. In another design of block 912, the transmitter may encode the first information to obtain multiple non-binary symbols. The transmitter may determine multiple subcarriers to use for the first information in multiple beacon symbols based on the multiple non-binary symbols, with one subcarrier being determined for each beacon symbol based on a corresponding non-binary symbol. The transmitter may then generate each beacon symbol comprising the first information mapped to one subcarrier. The transmitter may encode and send the first information in other manners.

The first information may comprise a cell ID, a sector ID, and/or other information. The second information may comprise pilot, control information, traffic data, or a combination thereof. The second information may be for channels such as a data channel (DCH), a common pilot channel (CPICH), a dedicated pilot channel (DPICH), etc.

FIG. 10 shows a design of an apparatus 1000 for transmitting information in a wireless communication system. Apparatus 1000 includes a module 1012 to map first information to at least one subcarrier in a first set of subcarriers, with the first information being conveyed by the position of the at least one subcarrier, a module 1014 to map second information to one or more subcarriers in a second set of subcarriers, and a module 1016 to generate at least one beacon symbol comprising the first information mapped to the at least one subcarrier in the first set and the second information mapped to the one or more subcarriers in the second set.

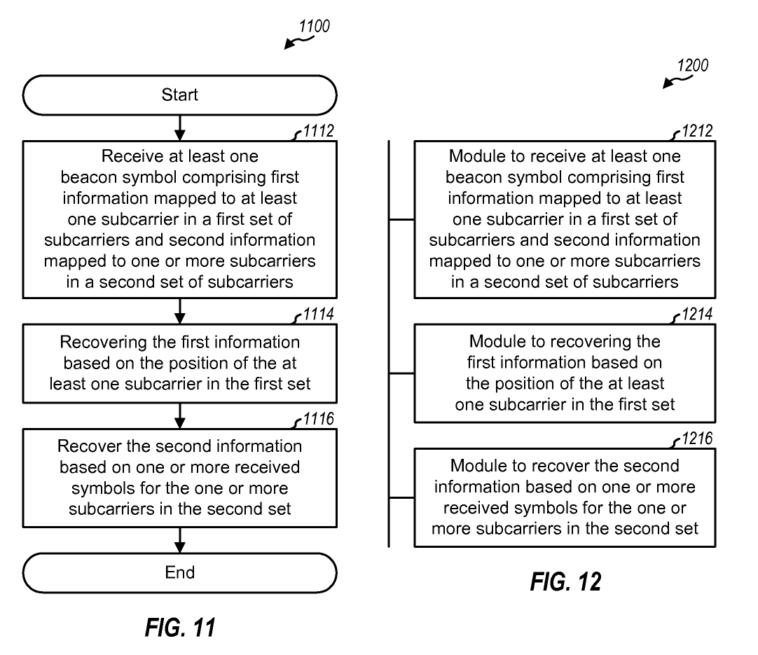

FIG. 11 shows a design of a process 1100 for receiving information in a wireless communication system. Process 1100 may be performed by a receiver, which may be a terminal, a base station, or some other entity.

The receiver may receive at least one beacon symbol comprising first information mapped to at least one subcarrier in a first set of subcarriers and second information mapped to one or more subcarriers in a second set of subcarriers (block 1112). The receiver may recover the first information based on the position of the at least one subcarrier in the first set (block 1114). The receiver may recover the second information based on one or more received symbols for the one or more subcarriers in the second set (block 1116).

In one design, the first information may be frequency division multiplexed with the second information, and the first set of subcarriers may be non-overlapping with the second set of subcarriers. In another design, the first information may puncture the second information on the at least one subcarrier, and the first set of subcarriers may overlap the second set of subcarriers. For this design, the receiver may discard at least one received symbol for the at least one subcarrier used for the first information and may process received symbols for remaining subcarriers in the second set to recover the second information.

In one design, the receiver may compare the received power of each subcarrier in the first set against a threshold. The receiver may identify the at least one subcarrier used for the first information based on the comparison results. The receiver may then decode at least one non-binary symbol corresponding to the at least one subcarrier to obtain the first information.

In another design, the receiver may receive multiple beacon symbols comprising the first information mapped to one subcarrier in each beacon symbol. The receiver may recover the first information by performing hard-decision and/or soft-decision decoding on the received symbols from the multiple beacon symbols. For hard-decision decoding, the receiver may determine the one subcarrier used for the first information in each beacon symbol. The receiver may obtain multiple non-binary symbols for the multiple beacon symbols, one non-binary symbol for each beacon symbol. Each non-binary symbol may be determined based on the position of the one subcarrier used for the first information in the corresponding beacon symbol. The receiver may then decode the multiple non-binary symbols to recover the first information. For soft-decision decoding, the receiver may determine the total received power for each possible message for the first information by combining the receive powers of subcarriers used for that message in the multiple beacon symbols. The receiver may then determine the first information based on the total received powers for all possible messages.

FIG. 12 shows a design of an apparatus 1200 for receiving information in a wireless communication system. Apparatus 1200 includes a module 1212 to receive at least one beacon symbol comprising first information mapped to at least one subcarrier in a first set of subcarriers and second information mapped to one or more subcarriers in a second set of subcarriers, a module 1214 to recover the first information based on the position of the at least one subcarrier in the first set, and a module 1216 to recover the second information based on one or more received symbols for the one or more subcarriers in the second set.

The modules in FIGS. 10 and 12 may comprise processors, electronics devices, hardware devices, electronics components, logical circuits, memories, etc., or any combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of transmitting information in a wireless communication system, comprising:
mapping first information to at least one subcarrier in a first set of subcarriers, the first information being conveyed by position of the at least one subcarrier;
mapping second information to one or more subcarriers in a second set of subcarriers; and
generating at least one beacon symbol comprising the first information mapped to the at least one subcarrier in the first set and the second information mapped to the one or more subcarriers in the second set.

2. The method of claim 1, wherein the second information is conveyed by one or more modulation symbols sent on the one or more subcarriers in the second set.

3. The method of claim 1, wherein the first information is frequency division multiplexed (FDM) with the second information, and wherein the first set of subcarriers is non-overlapping with the second set of subcarriers.

4. The method of claim 3, wherein system bandwidth is partitioned into multiple subbands, wherein the first set of subcarriers is in at least one of the multiple subbands, and wherein the second set of subcarriers is in remaining ones of the multiple subbands.

5. The method of claim 1, wherein the first information punctures the second information on the at least one subcarrier.

6. The method of claim 1, further comprising:
determining first transmit power for the first information;
determining second transmit power for the second information;
using the first transmit power for at least one modulation symbol sent on the at least one subcarrier in the first set for the first information; and
using the second transmit power for one or more modulation symbols sent on the one or more subcarriers in the second set for the second information.

7. The method of claim 6, wherein the determining the first transmit power comprises determining the first transmit power based on a predetermined percentage of available transmit power or an amount of transmit power to achieve a target reliability for the first information.

8. The method of claim 1, wherein the mapping the first information comprises
encoding the first information to obtain at least one non-binary symbol, and
determining the at least one subcarrier based on the at least one non-binary symbol.

9. The method of claim 1, wherein the mapping the first information comprises
encoding the first information to obtain multiple non-binary symbols, and
determining multiple subcarriers to use for the first information in multiple beacon symbols based on the multiple non-binary symbols, with one subcarrier being determined for each beacon symbol based on a corresponding non-binary symbol, and wherein the generating the at least one beacon symbol comprises generating each of the multiple beacon symbols comprising the first information mapped to the one subcarrier determined for the beacon symbol.

10. The method of claim 1, wherein the first information comprises a cell identifier (ID) or a sector ID, and wherein the second information comprises pilot, control information, traffic data, or a combination thereof

11. An apparatus for wireless communication, comprising:
at least one processor configured to map first information to at least one subcarrier in a first set of subcarriers, the first information being conveyed by position of the at least one subcarrier, to map second information to one or more subcarriers in a second set of subcarriers, and to generate at least one beacon symbol comprising the first information mapped to the at least one subcarrier in the first set and the second information mapped to the one or more subcarriers in the second set.

12. The apparatus of claim 11, wherein the at least one processor is configured to frequency division multiplex the first information with the second information, and wherein the first set of subcarriers is non-overlapping with the second set of subcarriers.

13. The apparatus of claim 11, wherein the at least one processor is configured to puncture the second information on the at least one subcarrier with the first information.

14. The apparatus of claim 11, wherein the at least one processor is configured to encode the first information to obtain multiple non-binary symbols, to determine multiple subcarriers to use for the first information in multiple beacon symbols based on the multiple non-binary symbols, with one subcarrier being determined for each beacon symbol based on a corresponding non-binary symbol, and to generate each of the multiple beacon symbols comprising the first information mapped to the one subcarrier determined for the beacon symbol.

15. An apparatus for wireless communication, comprising:
means for mapping first information to at least one subcarrier in a first set of subcarriers, the first information being conveyed by position of the at least one subcarrier;
means for mapping second information to one or more subcarriers in a second set of subcarriers; and
means for generating at least one beacon symbol comprising the first information mapped to the at least one subcarrier in the first set and the second information mapped to the one or more subcarriers in the second set.

16. The apparatus of claim 15, wherein the first information is frequency division multiplexed (FDM) with the second information, and wherein the first set of subcarriers is non-overlapping with the second set of subcarriers.

17. The apparatus of claim 15, wherein the first information punctures the second information on the at least one subcarrier.

18. The apparatus of claim 15, wherein the means for mapping the first information comprises
means for encoding the first information to obtain multiple non-binary symbols, and
means for determining multiple subcarriers to use for the first information in multiple beacon symbols based on the multiple non-binary symbols, with one subcarrier being determined for each beacon symbol based on a corresponding non-binary symbol, and wherein the means for generating the at least one beacon symbol comprises means for generating each of the multiple beacon symbols comprising the first information mapped to the one subcarrier determined for the beacon symbol.

19. A computer program product, comprising:
a computer-readable medium comprising:
code for causing at least one computer to map first information to at least one subcarrier in a first set of subcarriers, the first information being conveyed by position of the at least one subcarrier,
code for causing the at least one computer to map second information to one or more subcarriers in a second set of subcarriers, and
code for causing the at least one computer to generate at least one beacon symbol comprising the first information mapped to the at least one subcarrier in the first set and the second information mapped to the one or more subcarriers in the second set.

20. A method of receiving information in a wireless communication system, comprising:
receiving at least one beacon symbol comprising first information mapped to at least one subcarrier in a first set of subcarriers and second information mapped to one or more subcarriers in a second set of subcarriers;
recovering the first information based on position of the at least one subcarrier in the first set; and
recovering the second information based on one or more received symbols for the one or more subcarriers in the second set.

21. The method of claim 20, wherein the first information is frequency division multiplexed (FDM) with the second information, and wherein the first set of subcarriers is non-overlapping with the second set of subcarriers.

22. The method of claim 20, wherein the first information punctures the second information on the at least one subcarrier, wherein the recovering the second information comprises
discarding at least one received symbol for the at least one subcarrier used for the first information, and
processing received symbols for remaining subcarriers in the second set to recover the second information.

23. The method of claim 20, wherein the recovering the first information comprises
comparing received power of each subcarrier in the first set against a threshold, and
identifying the at least one subcarrier used for the first information based on comparison results.

24. The method of claim 20, wherein the receiving the at least one beacon symbol comprises receiving multiple beacon symbols comprising the first information mapped to one subcarrier in each beacon symbol, and wherein the recovering the first information comprises performing hard-decision decoding or soft-decision decoding on received symbols from the multiple beacon symbols to recover the first information.

25. The method of claim 20, wherein the receiving the at least one beacon symbol comprises receiving multiple beacon symbols comprising the first information mapped to one subcarrier in each beacon symbol, and wherein the recovering the first information comprises
determining the one subcarrier used for the first information in each beacon symbol,
obtaining multiple non-binary symbols for the multiple beacon symbols, one non-binary symbol for each beacon symbol, each non-binary symbol being determined based on position of the one subcarrier used for the first information in the corresponding beacon symbol, and
decoding the multiple non-binary symbols to recover the first information.

26. The method of claim 20, wherein the receiving the at least one beacon symbol comprises receiving multiple beacon symbols comprising the first information mapped to one subcarrier in each beacon symbol, and wherein the recovering the first information comprises
determining total received power for each of multiple possible messages for the first information by combining receive powers of subcarriers used for the message in the multiple beacon symbols, and
determining the first information based on total received powers for the multiple possible messages.

27. An apparatus for wireless communication, comprising:
at least one processor configured to receive at least one beacon symbol comprising first information mapped to at least one subcarrier in a first set of subcarriers and second information mapped to one or more subcarriers in a second set of subcarriers, to recover the first information based on position of the at least one subcarrier in the first set, and to recover the second information based on one or more received symbols for the one or more subcarriers in the second set.

28. The apparatus of claim 27, wherein the first information is frequency division multiplexed (FDM) with the second information, and wherein the first set of subcarriers is non-overlapping with the second set of subcarriers.

29. The apparatus of claim 27, wherein the first information punctures the second information on the at least one subcarrier, and wherein the at least one processor is configured to discard at least one received symbol for the at least one subcarrier used for the first information, and to process received symbols for remaining subcarriers in the second set to recover the second information.

30. The apparatus of claim 27, wherein the at least one processor is configured to receive multiple beacon symbols comprising the first information mapped to one subcarrier in each beacon symbol, and to perform hard-decision decoding or soft-decision decoding on received symbols from the multiple beacon symbols to recover the first information.
